(19) United States
(12) Patent Application Publication
(10) Pub. No.: US 2007/0247449 A1
(43) Pub. Date: Oct. 25, 2007

(54) Wireless display

(75) Inventors: Kevin James Mack, Berkeley, CA (US); Narayan Dhruvaraj Melgini, San Francisco, CA (US); Matthew Wise, Berkeley, CA (US)

Correspondence Address: KEVIN J. MACK, 242 CURTNER AVE SUITE N, PALO ALTO, CA, 94306, US

(73) Assignee: illumobile Corporation

(21) Appl. No.: 11/601,869

(22) Filed: Nov. 20, 2006

Related U.S. Application Data
(63) Continuation-in-part of application No. 11/409,319, filed on Apr. 24, 2006.

(51) Int. Cl. G09G 5/00

(52) U.S. Cl. 345/204

(57) ABSTRACT

A method and system for displaying visual content is disclosed. In some embodiments the system comprises a processor configured to process visual content that is to be displayed on the display, a storage coupled to the display and adapted to store the visual content, and a wireless interface configured to detect one or more viewers of the display when the one or more viewers are in physical proximity to the display.

### CROSS REFERENCE TO RELATED APPLICATIONS

This application is a continuation-in-part of U.S. patent application Ser. No. 11/409,319 filed Apr. 24, 2006.

### FIELD OF THE INVENTION

The invention relates generally to a system and method for communicating with a display device and, more particularly, to delivering personalized advertising content to a display device based on information sent wirelessly to the display device from one or more viewers of the display device.

### BACKGROUND

Billboards, signs, newspapers, posters, and flyers are conventional mediums for conveying information and ideas to the public. The information conveyed with these conventional mediums may generally comprise static information, such as advertisements and fixed promotional campaigns, and dynamic information, such as news, weather, stock quotes, and sports scores. Generally, public and private corporations, government agencies, and individuals will carefully craft the content and placement of their medium depending upon the characteristics of the audience that will view the content. For example, a corporation desiring to sell a high-end product to wealthy urbanities may erect a billboard in an affluent part of a major city. Conversely, an individual attempting to garner votes in a local election may canvass his relevant voting district with flyers and posters.

Unfortunately, conventional mediums of conveying information suffer from several shortcomings. First, conventional mediums are relatively expensive to widely deploy. The producers of the conventional mediums must manually disseminate them to their intended audience, which is a costly endeavor. Second, the producers of conventional mediums are incapable of updating the conveyed information after creation. Thus, conventional mediums are not well suited to conveying dynamic information. Third, as previously discussed, the placement of a conventional medium will determine its effectiveness. If adequate placement is not available, conventional mediums may not be pragmatic. Fourth, conventional mediums are difficult to tailor to specific regions or groupings of intended viewers. For example, the producer of a global advertising campaign will typically need to draft several versions of the advertisement in different languages, depending upon the countries in which the advertiser will disseminate the advertisement.

### BRIEF SUMMARY

A method and system for displaying visual content is disclosed. In some embodiments the system comprises a processor configured to process visual content that is to be displayed on the display device, a storage coupled to the display device and adapted to store the visual content, and a wireless interface configured to detect one or more viewers of the display device when the one or more viewers are in physical proximity to the display device. In accordance with at least some embodiments of the invention, a system and associated method comprise discovering an identifier associated with a wireless transceiver located within physical proximity of a display, correlating the identifier with one or more personal preferences associated with a user of the wireless transceiver, and displaying personalized content on the display based, at least in part, on the one or more personal preferences.

### BRIEF DESCRIPTION OF THE DRAWINGS

For a detailed description of exemplary embodiments of the invention, reference will now be made to the accompanying drawings in which:

FIG. 1 illustrates an exemplary system constructed in accordance with embodiments of the invention;

FIG. 2 depicts the display of FIG. 1 in greater detail;

FIG. 3 illustrates an exemplary network constructed in accordance with embodiments of the invention;

FIG. 4 depicts an exemplary display system constructed in accordance with embodiments of the invention;

FIG. 5 illustrates a flow chart for an exemplary method of displaying personalized content on a display device in accordance with embodiments of the invention;

FIG. 6 depicts a flow chart for an exemplary method of wirelessly connecting a user to a display device in accordance with embodiments of the invention; and

FIG. 7 illustrates a flow chart for an exemplary method for trading and auctioning spots on a network of display devices.

### NOTATION AND NOMENCLATURE

In the following discussion and in the claims, the terms “including” and “comprising” are used in an open-ended fashion, and thus should be interpreted to mean “including, but not limited to”. Also, the term “couple” or “couples” is intended to mean either an indirect or direct electrical or communicative connection. Thus, if a first device couples to a second device, that connection may be through a direct connection, or through an indirect connection via other devices and connections.

### DETAILED DESCRIPTION

In this disclosure, numerous specific details are set forth to provide a sufficient understanding of the present invention. Those skilled in the art, however, will appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise. Moreover, certain terms are used throughout the following description and claims to refer to particular system components. As one skilled in the art will appreciate, components may be referred to by different names. This document does not intend to distinguish between components that differ in name, but not function.

The following discussion is also directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be illustrative of that embodiment, and not intended to suggest that the scope of the disclosure, including the claims, is limited to that embodiment.

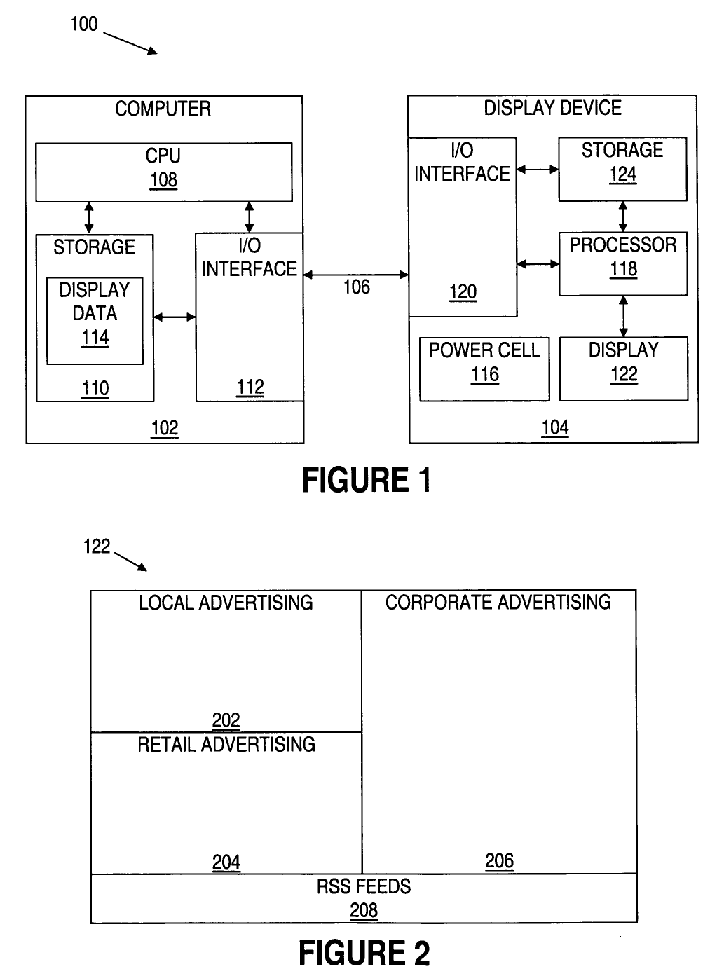

FIG. 1 illustrates a system 100 constructed in accordance with embodiments of the invention. System 100 comprises a computer 102 coupled to a display device 104 by a communications channel 106. The computer 102 may be any type of computer system, such as a laptop computer, a personal computer, or a stand-alone computer operated as a server. The computer 102 comprises a central processing unit (CPU) 108, a storage 110, and an Input/Output (I/O) interface 112. As illustrated in FIG. 1, the computer 102 may comprise a single CPU 108, or may comprise a plurality of CPUs arranged in a configuration where parallel computing may take place. The CPU 108 couples to the storage 110 which stores display data 114. The storage 110 may comprise any type of volatile and/or non-volatile memory, such as random access memory (RAM) and read only memory (ROM), or any other medium for storing information, such as a hard drive, universal serial bus (USB) flash drive, memory stick, cell phone, and iPod®. The display data 114 may comprise any type of static, semi-static, or dynamic visual content, such as still images and text, motion pictures, animated graphics, and advertisements in any type of representation, such as binary data. The storage 110 couples to the I/O interface 112 to transmit the display data 114 through the communications channel 106 to the display device 104. In some embodiments, the computer 102 and the display device 104 are integrated into a single unit.

As illustrated in FIG. 1, display device 104 comprises a power cell 116, a processor 118, an I/O interface 120, a display 122, and a storage 124. The display data 114 may be transferred from the computer 102 to the display device 104 via the communications channel 106 and the I/O interfaces 112 and 120. The I/O interfaces 112 and 120 may comprise any communications interface adapted to send and receive data via the communication channel 106. Such communication interfaces may comprise a Wi-Fi, cellular, pager, or satellite transceiver, a USB interface for receiving a USB flash drive, a FireWire interface, or any other type of communications interface capable of receiving data through the communications channel 106, such as an interface adaptor for an iPod®.

The communications channel 106 comprises any type of wireless and/or wire line communications channel that facilitates the transfer of the display data 114 from the computer 102 to the display device 104. Depending upon the data rate desired, various wireless and wire line technologies may be employed. For example, in wireless embodiments, the communication channel 106 may employ a communications protocol or standard, such as Wi-Fi (i.e., Institute of Electrical and Electronics Engineers (IEEE) 802.11 and its variants), Global System for Mobile communication (GSM), Code-Division Multiple Access (CDMA) and its variants (e.g., Wideband CDMA (W-CDMA), Broadband CDMA (B-CDMA), Time Division CDMA (TD-CDMA), and CDMA2000), Orthogonal Frequency Division Multiplexing (OFDM) and it variants, General Packet Radio Service (GPRS), Enhanced Data rates for GSM Evolution (EDGE), any other second (2G), third (3G), or fourth (4G) mobile technology, Bluetooth, and Infrared (IrDA). Paging technologies, such as Post Office Code Standardization Advisory Group (POCSAG), FLEX, ReFLEX, and InFLEXion may also be used. In some wire line embodiments, a keyboard or other input device may be connected to the display device 104 to create and transfer the display data 114. In these wire line embodiments, the computer 102 is optional and the keyboard or other input device creates and facilitates the transfer of the display data 114 to the display device 104.

The processor 118 preferably includes a clock or oscillator that provides timing for the components of the display device 104. In at least some embodiments, the timing for the display device 104 is provided by a phase-locked-loop (PLL) circuit. The processor 118 may process, convert, modify, arrange, and/or transform the display data 114. In addition, the processor 118 may perform functions necessary for content to be displayed on the display 122 and for proper operation of the display device 104. The processor may comprise any type of software and/or hardware that is capable of processing the display data 114, such as Intel's PXA27x family of microprocessors, Texas Instruments' TCS3500 chip set, or a field programmable gate array (FPGA).

The storage 124 couples to the I/O interface 120 and stores data that is to be displayed on the display 122. The storage 124 may comprise any type of volatile memory and/or non-volatile memory, such as random access memory (RAM) and read only memory (ROM), or any other medium for storing information, such as a hard drive, Universal Serial Bus (USB) Flash drive, memory stick, cell phone, and an iPoD®. In some embodiments, the storage 124 contains preconfigured data and functions, such as compression/decompression algorithms, priority display functions, audio/video codecs, audio visualization functions, text translation functions, music lyric lookup functions, and closed caption lookup functions. The processor 118 may utilize the preconfigured data and functions to perform tasks associated with the operation of the display device 104. For example, the processor 118 may utilize a text translation function stored in the storage 124 to translate display data text from one language to another before being displayed on the display 122. Another example includes the automated lookup of song lyrics. In this example, once an audio device, such as an iPod®, is coupled to the display device 104 via the I/O interface 120, the processor 118 may execute the audio visualizations and lyric lookup functions for a particular song to display audio visualizations and the lyrics of the song on the display 122. Similarly, a closed caption decoder may be stored in the storage 124 to provide the capability to display captions for visual content, such as movies, movie pictures, animations, and advertisements.

Priority display functions may also be stored in the storage 124 to control the type of content displayed on the display 122. For example, a priority display function may determine when the display device 104 may display user-created content and when advertisements are displayed. As can be appreciated, such priority functions may control the type of content that is displayed on the display 122, thereby facilitating various types of advertising business models. For example, one business model may permit advertisements to be displayed on the display 122 a configurable percentage of the time that the display device 104 is active and operational. Under this exemplary business model, a user would only be able to display user-created content during times when advertisements were not being displayed, thereby creating a priority scheme for the various types of content. If the user attempts to display lower priority, user-created content while a priority function has locked out the user, the user's content may optionally be queued for display after the advertisements have been displayed. This queuing process may store the lower priority content in the storage 124.

In some embodiments, the preconfigured data and functions, as well as the priority display functions, may be stored external to the display device 104, for example in a server coupled to the display device 104 via the Internet. In these embodiments, the display device 104 sends a request with data to the external source and receives a reply containing the data after it has been processed by the function indicated in the request.

In other embodiments, the communications channel 106 represents the physical transportation of data by a physical storage device, such as the transfer of data from the computer 102 to the display device 104 via a USB flash drive. In these embodiments a user physically connects a storage device containing the display data 114 to the display device 104. The display device 104 detects the connection of the storage device, accesses the data stored on the storage device, and displays this data on the display 122 after being optionally processed and formatted by the processor 118.

The display device 104 may optionally includes a global position locator to be used in conjunction with a global position system (GPS). The global position locator allows the physical location of the display device 104 to be determined. The global position locator may be powered by the power cell 116 and may optionally utilize components of the I/O interface 120 to transmit its GPS signal. The display device 104 may also optionally include a motion detector. The motion detector may detect when an object of person is near the display device 104.

In some embodiments, the power cell 116 is coupled to a timer which detects the time that has elapsed since a predetermined condition has occurred. Such conditions may comprise the last time content was displayed on the display 122, the last time an active wireless connection was established by the I/O interface 120, or any other event detectable by the timer. After the timer is initialized and a predetermined time has elapsed from the occurrence of a condition, the display device 104 may enter into a power saving mode, in which non-critical circuitry is either powered off or set to a reduced power state. As can be appreciated, such embodiments preserve the energy stored in the power cell 116, thereby increasing the amount of time that the power cell 116 may power the display device 104.

The power cell 116 may produce energy to either fully or partially power the display device 104. The power cell 116 may comprise alkaline, nickel-cadmium (NiCd), any other type of battery or an AC or DC power source. In at least some embodiments, renewable energy source, such as kinetic or solar power, are employed to power the display device 104. For example, solar power cells or panels may be employed to fully or partially power the display device 104. In at least some embodiments, the power cell 116 is used in conjunction with a secondary power source, such as a car battery, to power the display device 104.

FIG. 2 shows the display 122 in more detail. The display 122 may represent an LCD display, a plasma display, a grid of light emitting diodes (LEDs), or any other means of displaying content, such as photosensors, electronic ink, organic light-emitting diodes (OLEDs), transparent OLEDs, and solid state lighting (SSL) LEDs. LEDs are semiconductor devices that emit light when electrically biased in the forward direction. The color of the emitted light depends on the chemical composition of the semiconducting material used, and can be near-ultraviolet, visible or infrared.

As shown in FIG. 2, the display 122 is preferably segmented into a plurality of sections 202-208. Each section comprises a defined type of media content. For example, section 202 may comprise local, non-retail advertising, section 204 may comprise local, retail advertising, section 206 may comprise corporate advertising, and section 208 may comprise RSS feeds. The RSS feeds may utilize standards, such as Really Simple Syndication (RSS 2.0), Rich Site Summary (RSS 0.91, RSS 1.0), RDF Site Summary (RSS 0.9 and 1.0), or any other means for aggregating dynamic content. Each segment may be implemented as a frame of a webpage written in dynamic HTML or any language suitable for displaying static and dynamic content. This content may comprise full motion video, animation, news, weather, sport scores, or any other type of information that may be conveyed on the display 122. Although shown in FIG. 2 as segmented into four sections 202-208, the display 122 may comprise any number of sections depending upon the desired configuration of the display. The size and location of each section may also be modified as desired.

In at least some embodiments, the display 122 is positioned inside of a storefront window so as to permit viewers outside of the store to view the display. Generally, such viewers comprise pedestrians and vehicular traffic. In other embodiments, the display 122 is attached to the inside of a vehicle's translucent window. For example, the display 122 may be attached the inside rear window of a vehicle, such as a truck, van, car, bus, taxi, train, airplane, and military vehicle. Fasteners may allow for the display 122 to be positioned in various angles, depending upon the desired viewing angle for the intended audience of the display 122.

As can be appreciated by one skilled in the art, the foregoing discussion is directed to the design associated with a display system. Various additional components of the system 100, such as servers, databases, and software applications, may be utilized to implement each of the components of the computer 102 and the display device 104. Moreover, many of the components of the system 100 may be implemented in either hardware, software, or a combination thereof.

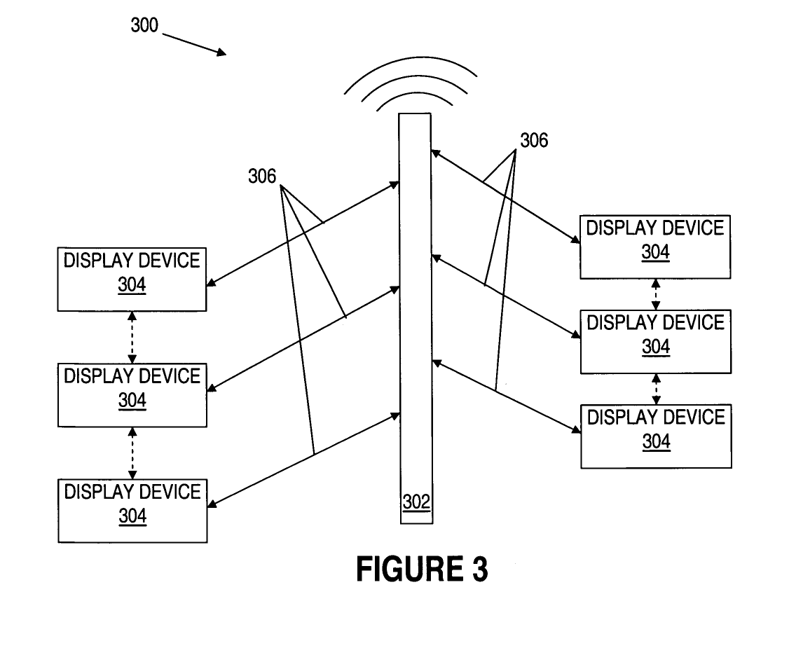

FIG. 3 illustrates an exemplary network 300 in accordance with embodiments of the invention. The network 300 comprises one or more transmission towers 302 and a plurality of display devices 304. The display devices 304 are coupled to the transmission tower 302 via transmission channels 306. The transmission tower 302 may be representative of a cellular tower, or any other transmission medium, such as a Wi-Fi access point or pager tower. As shown in FIG. 3, the display devices 304 may optionally be coupled together via communications channels to facilitate the transfer of data among the display devices 304, thereby creating a network of interlinked display devices. Each display device 304 may represent a client on the network 300. Accordingly, in some embodiments that employ Wi-Fi technology to connect the display device to the Internet via Transmission Control Protocol/Internet Protocol (TCP/IP), each display device 304 may be assigned a unique IP address.

Although six display devices are illustrated in FIG. 3, any number of display devices may be connected to the network 300. Once a network of display devices is established, content may be selectively displayed on the networked display devices. For example, an advertiser may desire to display a particular advertisement in a particular region. After determining the desired region, the advertisement may be sent only to the networked display devices located in the particular region. The current location of the display device may be determined in a number of ways. For example, the location may be inferred from the display device's IP address or determined from a GPS locator embedded in the display device. Alternatively, the display device may be installed in a fixed, known location, such as in the window of a building.

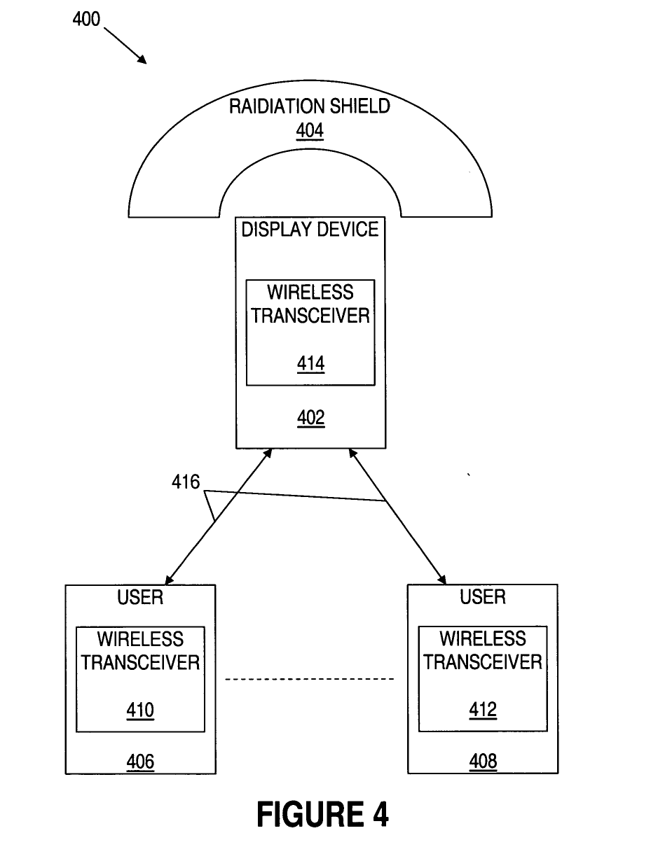

FIG. 4 illustrates an exemplary display system 400 in accordance with embodiments of the invention. The display system 400 comprises a display device 402, a radiation shield 404 and one or more users 406-408. Each user 406408 preferably possesses a wireless transceiver 410-412 that transmits data to a wireless transceiver 414 coupled to the display device 402 via one or more wireless communication links 416. For example, each user 406-408 may carry a communications device, such as cellular phone, PDA, and pocket PC, with the wireless transceivers 410-412 embedded therein.

The wireless communication links 416 may comprise any type of wireless data link, such as Wi-Fi (i.e., Institute of Electrical and Electronics Engineers (IEEE) 802.11 and its variants), Global System for Mobile communication (GSM), Code-Division Multiple Access (CDMA) and its variants (e.g., Wideband CDMA (W-CDMA), Broadband CDMA (B-CDMA), Time Division CDMA (TD-CDMA), and CDMA2000), Orthogonal Frequency Division Multiplexing (OFDM) and it variants, General Packet Radio Service (GPRS), Enhanced Data rates for GSM Evolution (EDGE), any other second (2G), third (3G), or fourth (4G) mobile technology, Bluetooth, and Infrared (IrDA). The wireless transceivers 410-412 transmit data to the display device 402 through the wireless communication links 416. In some embodiments, the display device also transmits data to the wireless transceivers 410-412 through the wireless transceiver 414. Although each user 406-408 is shown in FIG. 4 as directly connecting to the display device 402, in at least some embodiments, the connection is indirectly created through other devices, such as a connection through multiple nodes on the Internet.

The radiation shield 404 blocks configurable types of electromagnetic radiation to ensure that the display device 402 receives wireless signals from the users 406-408 and not from users who are not trying to interact, use, and/or view the display device 402. The radiation shield 404 may comprise ceramic, conductive, or any other material that absorbs, eliminate, shields, or deflects electromagnetic radiation. As shown in FIG. 4, the radiation shield 404 may effectively block electromagnetic radiation emanating from behind the display device 402, thereby permitting the wireless transceiver 404 to receive electromagnetic radiation only from users that are roughly in front of the display device 402. Such users would presumably be viewing content on the display device 402. Although shown in FIG. 4 as blocking radiation emanating from the rear of the display device 402, the radiation shield 404 may be placed in any location or configuration that shields the wireless transceiver 414 from a desired type or location of electromagnetic radiation. In addition, in at least some embodiments the radiation shield 404 is integrated into the display device 402 and/or the wireless transceiver 414.

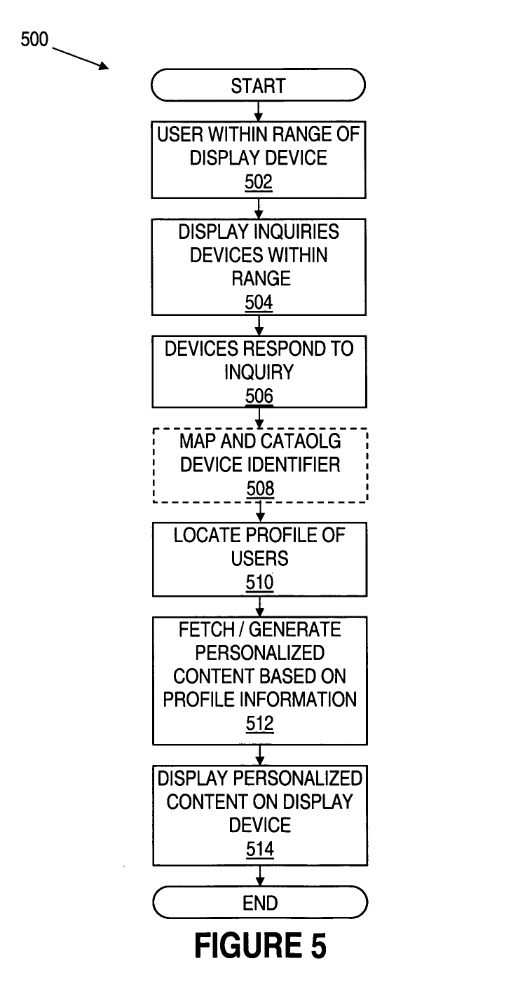

FIG. 5 illustrates a flow chart for an exemplary method 500 of displaying personalized content on a display device in accordance with embodiments of the invention. The method 500 begins when a user that possesses a wireless transceiver comes within range of a display device (502). This range is preferably defined by the effective range of the wireless transceiver coupled to the display and the wireless transceiver of the user. For example, if the display device contains a class 2 Bluetooth transceiver, a user's Bluetooth transceiver may be detected within a range of approximately 10 meters from the display device. When a user is within range, the wireless transceiver coupled to the display device discovers devices within range through an inquiry procedure (504). Typically, any device that is discoverable within the range of the transceiver will respond to the inquiry procedure with one or more identifiers, such as a device identifier, a vendor identifier (VID), a product identifier (PID), a universally unique identifier (UUID), or a combination thereof (506). For example, a user could possess a cell phone that has a Bluetooth transceiver embedded and enabled. When the user comes within range of the display device, the display device inquires the cell phone's Bluetooth transceiver and receives one or more identifiers from the cell phone in response to this inquiry. After receiving the one or more identifiers, the display device optionally maps the identifiers to one or more users and catalogs the identifiers, along with a time stamp (508). This optional mapping may be accomplished by querying a database that matches an identifier to an individual user or groups of users. After the optional mapping, a profile database contained within the display device, or coupled externally to the display device, is queried for profile information associated with the mapped user or the received identifier (510). The profile information may comprise any data associated with mapped user or identifier, such as name, address, gender, height, weight, hobbies, and personal preferences. The display device then fetches or generates personalized content, based in part, on the profile information (512). The method 500 ends when the personalized content is displayed on the display device (514).

As can be appreciated by one of skill in the art, the foregoing method enables the automatic detection of users and the automatic generation of personalized content on a display device in real-time. In practice, the display device may detect a user even before the user is capable of viewing the display device. For example, a user may be detected via a Bluetooth enabled wireless device contained on the user's person at a range of 10 meters. Steps 504-514 may be performed in real-time, allowing personalized content to be displayed before the user is within visual proximity of the display device. Thus, the display device may generate personalized content, such as focused advertisements and news, before the user is even capable of viewing the display device so as to create a more personalized viewing experience. Although Bluetooth is utilized to illustrate the method 500, any short or long range wireless communication protocol may be used as desired, such as infrared, Wi-Fi, and GSM.

In addition, the display device may also utilize the signal integrity and signal strength of a wireless transceiver to further refine the detection of users. For example, when a device responds to the inquiry (step 506), the signal integrity and signal strength of the wireless transceiver associated with the device may be used to determine a more precise distance from the display device. As can be appreciated by one skilled in the art, a wireless transceiver's signal strength and integrity are related to the distance the wireless transceiver is from the node with which it is communicating. For example, signal strength may degrade inversely proportional to the distance squared. The display device may use such relationships along with a wireless transceiver's signal strength and/or signal integrity to better infer a user's position.

In some embodiments, the display device is also capable of determining the interval of time a user spends within the range of the display device. For example, steps 502-506 may be performed iteratively, allowing for the detection and the determination of an interval in which one or more users is within range of the display device. This interval may correlate to the amount of time a user observed the display device. Based on this interval, a user's preferences may be inferred by observing the user's response to the content displayed on the display device. For example, if a particular user is detected within range of the display for an interval of three minutes, and the display device was displaying a sports show or commercial during this three minutes, it may be inferred that the user is interested in sports related content. Thus, the display device, or a system coupled to the display device, may correlate the content displayed on the display device with the interval of time a user remains within the range of the display device. Such a process allows the display to identify preferences of the user through the conduct of the user. The display device therefore learns information about users' preferences and habits over time and can dynamically customize the content of the display based, at least in part, on these preferences and habits. As can be appreciated by one skilled in the art, this information may be the basis for many data mining applications that optimize the generation and display of content of the display device. Various embodiments of the invention perform such data mining operations based, at least in part, on the information inferred from a user's physical proximity to the display device and the interval of this proximity.

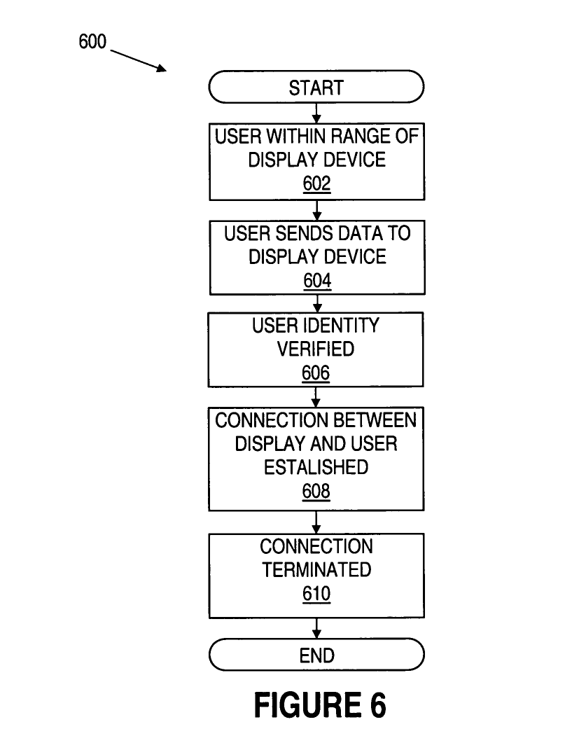

FIG. 6 illustrates a flow chart for an exemplary method 600 of wirelessly connecting a user to a display device in accordance with embodiments of the invention. The method 600 begins when a user comes within proximity of a display device (602). This range is defined by the effective range of the wireless transceiver coupled to the display. For example, if the display device is coupled to an infrared transceiver, the user would be detected roughly within a range of 1 meter from the display. When a user is within range, a wireless transceiver coupled to the user transmits data to the display device (604). Typically, this data will comprise a unique identifier, such as a device identifier, a vendor identifier (VID), a product identifier (PID), a universally unique identifier (UUID), or a combination thereof. For example, a user could possess a cell phone that has Bluetooth enabled. When the user comes within range of the display device, the cell phone, which is in service discovery mode, transmits a unique infrared identifier to the display device. The display device then verifies the identity of the user preferably based, at least in part, on the unique identifier (606). This verification may take place at the display device or externally to the display device, such as on a verification server coupled to the display device via the Internet.

After verification is complete, a wireless connection is established between the display device and the user's wireless transceiver (608). This connection may comprise any type of wireless connection, such as Wi-Fi, GSM, and infrared. In some embodiments, the connection is a Bluetooth connection employing one or more various Bluetooth profiles, such as Advanced Audio Distribution Profile (A2DP), Audio/Video Control Transport Protocol (AVCTP), Audio/Video Distribution Transport Protocol (AVDTP), AudioNideo Remote Control Profile (AVRCP), Basic Imaging Profile (BIP), Basic Printing Profile (BPP), Bluetooth Network Encapsulation Protocol (BNEP), Common ISDN Access Profile (CIP), Cordless Telephony Profile (CTP), Dial-up Networking Profile (DUN), Extended Service Discovery Profile (ESDP), Fax Profile (FAX), File Transfer Profile (FTP), Generic Access Profile (GAP), General AudioNideo Distribution Profile (GAVDP), Generic Object Exchange Profile (GOEP), Hands-Free Profile (HFP), Hard Copy Cable Replacement Profile (HCRP), Headset Profile (HSP), Human Interface Device Profile (HID), Intercom Profile (ICP), Object Exchange (OBEX), Object Push Profile (OPP), Personal Area Networking Profile (PAN), Service Discovery Protocol (SDP), Service Discovery Application Profile (SDAP), SIM Access Profile (SAP), Serial Port Profile (SPP), Synchronization Profile (SYNC), Telephony Control Specification (TCS-Binary or TCP), Video Distribution Profile (VDP), and WAP Over Bluetooth Profile (WAP). The method 600 ends when the wireless connection is terminated (610).

In some embodiments of the invention, a wireless connection may be established between the display device and the user to eliminate or reduce noise pollution. For example, by streaming audio through a wireless channel after the display device verifies the identifier of the user's wireless transceiver, audio may be streamed without a conventional speaker system. This audio stream may be streamed to a plurality of users simultaneously via a one-to-many mode of operation.

As can be appreciated by one of ordinary skill in the art, the method 600 enables an interactive experience between one or more users and a display device without any direct contact between the display device and the user. The connection could be used to transfer information, such as coupons related to advertisements displayed on the display device, or media, such as an audio or video, or any other type of information related to the content on the display device or a request sent by the user.

In at least some embodiments, a user may interact with a display device through a messaging service, such as short message service (SMS) or the Internet. In these embodiments, the user sends information through the service either directly to the display device or to a server coupled to the display device but external to it. For example, a user may use a cell phone to send a text message via SMS to a number identified on the display device. The text message may comprise a request for personalized content that is received and handled by the external server before being displayed on the display device. As can be appreciated by one of skill in the art, the external server may be connected to the Internet and may have a vast amount of content readily accessible. Such content may comprise driving or walking directions, maps, local transit schedules, news, sports, weather, restaurant reviews and menus, or any other type of dynamic or static content related to the user's request.

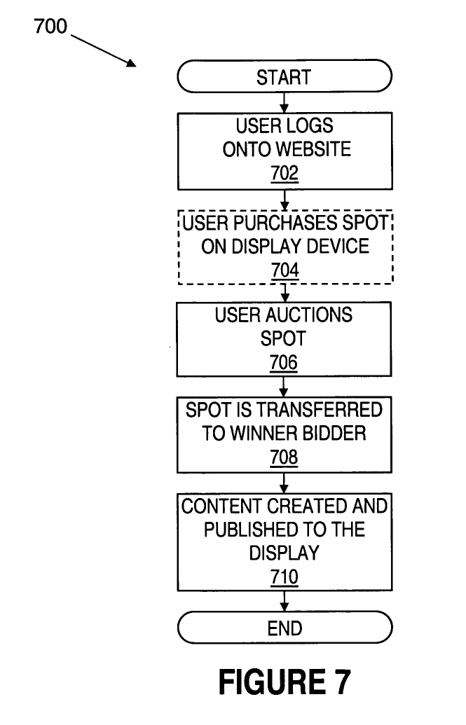

FIG. 7 illustrates a flow chart for an exemplary method 700 for trading and auctions spots on a network of display devices. The method 700 begins when a user logs onto an auction based website (702). Once logged onto the website, the user may optionally purchase “spots” on a network of display devices (704). For example, a user may be an advertiser wishing to place an advertisement on one or more display devices in the network. The advertiser may purchase a thirty second spot that permits the advertiser to place an advertising campaign on one or more display devices in the network during a specified time period. After the user purchases the spot, the user may auction the spot via an electronic auctioning system (706). Other users may bid on the auctioned spot until the auction ends, at which time a user wins the auction for the particular spot and ownership of the spot is transferred to the winner (708). The method 700 ends when the winning user creates, publishes, and schedules content to the appropriate display during the spot won (710). This step also preferably occurs online through a graphical user interface. As can be appreciated by one of skill in the art, the foregoing method permits users to purchase, sell, auction, and trade spots on a network of display devices. Although thirty seconds is given as an example of a typical spot, in practice the spots may comprise any duration of time. In some embodiments, spots are defined by geography, by time, by affiliation, or any other metric used by the network to segment content.

Although the steps for methods 500, 600, and 700 are given in a predefined order, the steps may be similarly performed out of order if desired. In addition, some steps may be added or dismissed from the foregoing exemplary methods when desirable. For example, if multiple users are in range of the display device, the display device or a server external to the display, but coupled to it, may use an algorithm to determine which personalized content to display. For example, if twenty users are viewing the display and a majority of these users have a preference for Italian food, directions to an Italian restaurant along with recent reviews of the restaurant and its current menu and pricing may be displayed. The algorithm itself is preferably dynamic in nature, actively monitoring when users enter and leave the effective range of a given display, or a predefined range stored in storage coupled to the display. In addition, when multiple display devices are networked together, the network may exploit knowledge of the device's physical location to extrapolate which users may be in range of a particular display device at a given time and display personalized content as necessary. For example, if a user leaves the range of a first display device, a signal may be sent to neighboring display devices indicating that the user is near these neighboring displays and provide an expected time for the user's arrival. These neighboring displays may pre-fetch personalized content and either display such content in expectation of the user or cache such content so that when the user is within range, the content does not need to be fetched or a profile associated with the user does not need to be ascertained.

The above discussion is meant to be illustrative of the principles and various embodiments of the present invention. Numerous variations and modifications will become apparent to those skilled in the art once the above disclosure is fully appreciated. For example, a display device may be coupled to the control circuitry of a vehicle. A wireless infrastructure may then facilitate the control of the vehicle and display of messages. As can be appreciated, such variations allow for unmanned operation of a vehicle and display of messages. It is intended that the following claims be interpreted to embrace all such variations and modifications.

What is claimed is:

1. A display, comprising:
a processor configured to process visual content that is to be displayed on the display;
a storage coupled to the display and adapted to store the visual content; and
a wireless interface configured to detect one or more viewers of the display when the one or more viewers are in physical proximity to the display.

2. The display of claim 1 further comprising a radiation shield adapted to prevent the wireless interface from detecting electromagnetic radiation emanating from sources other than the one or more viewers.

3. The display of claim 1 wherein the wireless interface comprises a short range wireless transceiver employing a protocol selected from the group consisting of Bluetooth, Infrared, and Wi-Fi.

4. The display of claim 1 wherein the display is physical mounted inside a building and is viewable only to people outside of the building.

5. The display of claim 1 wherein the wireless interface is adapted to determine the interval during which the one or more viewers is in physical proximity to the display.

6. The display of claim 1 wherein the display depicts personalized content associated with the one or more viewers based, at least in part, on an identifier sent wirelessly from the one or more viewers.

7. The display of claim 1 wherein the display depicts advertising content in a plurality of segmented areas.

8. The display of claim 1 wherein the storage contains an algorithm that determines what content is to be displayed on the display based, at least in part, on the preferences of the one or more viewers.

9. A method, comprising:
discovering an identifier associated with a wireless transceiver located within physical proximity to a display;
correlating the identifier with one or more preferences associated with a user of the wireless transceiver; and
displaying personalized content on the display based, at least in part, on the one or more preferences.

10. The method of claim 9 wherein discovering, correlating, and displaying occur in real-time.

11. The method of claim 9 wherein displaying comprises fetching content from a syndication feed.

12. The method of claim 9 further comprising transferring data to the wireless transceiver after the identifier is authenticated by the display.

13. The method of claim 9 further comprising establishing a short-range wireless connection between the wireless transceiver and the display.

14. The method of claim 9 further comprising sending a request for customized content through the cellular network.

15. The method of claim 9 wherein discovering comprises inquiring Bluetooth devices within range of the display.

16. A system, comprising:
means for processing visual information;
means for storing the visual information coupled to the means for processing visual information; and
means for detecting one or more users when the one or more users are in physical proximity to the means for processing visual information.

17. The system of claim 16 further comprising means for auctioning spots on the system.

18. The system of claim 16 further comprising means for trading spots on the system.

19. The system of claim 16 further comprising means for generating personalized content for the one or more users.

20. The system of claim 16 further comprising means for displaying segmented advertisements.
